(19) United States
(12) Patent Application Publication
(10) Pub. No.: US 2026/0105886 A1
(43) Pub. Date: Apr. 16, 2026

(54) Display Device

(71) Applicant: LG Display Co., Ltd., Seoul (KR)

(72) Inventors: Jinseong Kim, Paju-si (KR); Hyunsuk Cho, Paju-si (KR)

(21) Appl. No.: 19/309,018

(22) Filed: Aug. 25, 2025

(30) Foreign Application Priority Data
Oct. 10, 2024 (KR) 10-2024-0137739

(51) Int. Cl. G09G 3/3225

(52) U.S. Cl. CPC G09G 3/3225

(57) ABSTRACT

A display device includes a substrate, a first light-blocking layer disposed on the substrate and including a first scan line extending in a first direction, an active layer including a semiconductor area of a first transistor disposed on the first light-blocking layer, a gate layer including a gate electrode of the first transistor disposed on the active layer, a second transistor that receives a first scan signal from the first scan line and supplies a data voltage to the gate electrode of the first transistor, a source metal layer disposed on the gate layer and including an anode connection electrode that is directly connected to the active layer and receives a driving current flowing in the first transistor, a pixel electrode disposed on the source metal layer and directly connected to the anode connection electrode, a light-emitting layer disposed on the pixel electrode, and a common electrode disposed on the light-emitting layer.

### CROSS REFERENCE TO RELATED APPLICATION

The present application claims priority to Republic of Korea Patent Application No. 10-2024-0137739, filed on Oct. 10, 2024, which is hereby incorporated by reference in its entirety.

### BACKGROUND

### Field of Technology

The present specification relates to a display device.

### Description of the Related Art

As the information society develops, various demands for display devices for displaying images are increasing, and various types of display devices such as liquid crystal display (LCD) devices and organic light emitting diode (OLED) display devices are utilized.

Images displayed on a display device may be still images or moving images, and the moving image may include various types such as sports images, game images, and movies. The display device may include a plurality of pixels, and a plurality of switching elements for driving the pixels.

### SUMMARY

The present specification is directed to providing a display device in which it is possible to reduce the number of masks of a manufacturing process and reduce a manufacturing cost.

Objects of the present specification are not limited to the above-described objects, and other technical objects may be inferred from the following embodiments.

In one embodiment, a display device comprises: a substrate; a first light-blocking layer on the substrate, the first light-blocking layer including a first scan line extending in a first direction; an active layer including a semiconductor area of a first transistor, the active layer on the first light-blocking layer, a gate layer including a gate electrode of the first transistor, the gate layer on the active layer; a second transistor that receives a first scan signal from the first scan line and supplies a data voltage to the gate electrode of the first transistor; a source metal layer on the gate layer, the source metal layer including an anode connection electrode that is directly connected to the active layer and receives a driving current flowing in the first transistor; a pixel electrode on the source metal layer, the pixel electrode directly connected to the anode connection electrode; a light-emitting layer on the pixel electrode; and a common electrode on the light-emitting layer.

In one embodiment, a display device comprises: a substrate; a first light-blocking layer on the substrate; a first scan line that supplies a first scan signal, the first scan line in the first light-blocking layer and extends in a first direction; a second scan line that supplies a second scan signal, the second scan line in the first light-blocking layer and extends in the first direction; an active layer including a semiconductor area of a first transistor, the active layer on the first light-blocking layer; a gate layer including a gate electrode of the first transistor, the gate layer on the active layer; a first light-emitting control line that supplies a first light-emitting signal, the first light-emitting control line in the gate layer and extends in the first direction; a second transistor that receives the first scan signal and supplies a data voltage to the gate electrode of the first transistor; a third transistor that receives the second scan signal and supplies a reference voltage to the gate electrode of the first transistor; and a fourth transistor that receives the first light-emitting signal and supplies a driving voltage to a drain electrode of the first transistor.

In one embodiment, a display device comprises: a substrate; a first electrode of a first capacitor and a first scan line in a same layer on the substrate, the first electrode and the first scan line spaced apart from each other; a first buffer layer covering the first electrode and the first scan line; an active layer on the first buffer layer, the active layer including a first semiconductor area of a driving transistor and a second semiconductor area of an emission transistor; a second electrode of the first capacitor between the active layer and the first electrode of the first capacitor, the first buffer layer between the first electrode and the second electrode of the first capacitor; a gate layer on the active layer, the gate layer including a gate electrode of the driving transistor and a gate electrode of the emission transistor that is spaced apart from the gate electrode of the driving transistor, a first planarization layer over the gate layer; a source metal layer on the first planarization layer and including a connection electrode and an anode connection electrode that is spaced apart from the connection electrode, the connection electrode connected to the gate electrode of the driving transistor and the first electrode of the first capacitor and the anode connection electrode directly connected to the active layer; a pixel electrode on the source metal layer, the pixel electrode directly connected to the anode connection electrode; a light-emitting layer on the pixel electrode; and a common electrode on the light-emitting layer.

Detailed matters of other embodiments are included in the detailed description and accompanying drawings.

### BRIEF DESCRIPTION OF THE DRAWINGS

FIG. 1 is a block diagram illustrating a display device according to one embodiment.

FIG. 2 is a plan view illustrating a display device according to one embodiment.

FIG. 3 is a circuit diagram illustrating a circuit of the display device according to one embodiment.

FIG. 4 is a cross-sectional view illustrating the circuit of the display device according to one embodiment.

FIG. 5 is a layout view illustrating a pixel of the display device according to one embodiment.

FIG. 6 is a view illustrating some layers of the layout view of FIG. 5 according to one embodiment.

FIG. 7 is a view illustrating other layers of the layout view of FIG. 5 according to one embodiment.

FIG. 8 is a view illustrating other layers of the layout view of FIG. 5 according to one embodiment.

FIG. 9 is a view illustrating other layers of the layout view of FIG. 5 according to one embodiment.

FIG. 10 is a cross-sectional view along lines I-I′ in FIGS. 5 to 8 according to one embodiment.

FIG. 11 is a cross-sectional view along lines II-II′ in FIGS. 5 to 8 according to one embodiment.

FIG. 12 is a cross-sectional view along lines III-III′ in FIGS. 5 to 8 according to one embodiment.

FIG. 13 is a cross-sectional view along lines IV-IV′ in FIGS. 5 to 8 according to one embodiment.

### DETAILED DESCRIPTION

Hereinafter, embodiments will be described with reference to the accompanying drawings. In the specification, when a first component (or an area, a layer, a portion, etc.) is described as “on,” “connected,” or “coupled to” a second component, it means that the first component may be directly connected/coupled to the second component or a third component may be disposed therebetween.

The same reference numerals indicate the same components. In addition, in the drawings, thicknesses, proportions, and dimensions of components are exaggerated for effective description of technical contents. The term “and/or” includes all one or more combinations that may be defined by the associated configurations.

Terms such as first and second may be used to describe various components, but the components are not limited by the terms. The terms are used only for the purpose of distinguishing one component from another. For example, a first component may be referred to as a second component, and similarly, the second component may also be referred to as the first component without departing from the scopes of the embodiments. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof in advance.

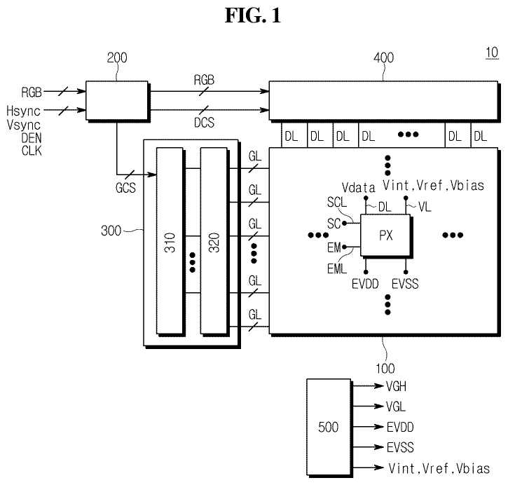

FIG. 1 is a block diagram illustrating a display device according to one embodiment.

Referring to FIG. 1, a display device 10 may be applied to portable electronic devices, such as a mobile phone, a smart phone, a tablet personal computer (PC), a mobile communication terminal, an electronic notebook, an electronic book, a portable multimedia player (PMP), a navigation device, an ultra-mobile PC (UMPC), etc. For example, the display device 10 may be applied to a television, a laptop, a monitor, a billboard, or a display unit of the Internet of Things (IOT). As another example, the display device 10 may be applied to a wearable device, such as a smart watch, a watch phone, a glasses-type display, and a head mounted display (HMD).

A display device 10 may include a display panel 100, a controller 200, a gate driving unit 300 (e.g., a circuit) that supplies gate signals to a plurality of pixels PX, a data driving unit 400 (e.g., a circuit) that supplies data voltages to the plurality of pixels PX, and a power supply unit 500 (e.g., a circuit) that supplies power to the plurality of pixels PX.

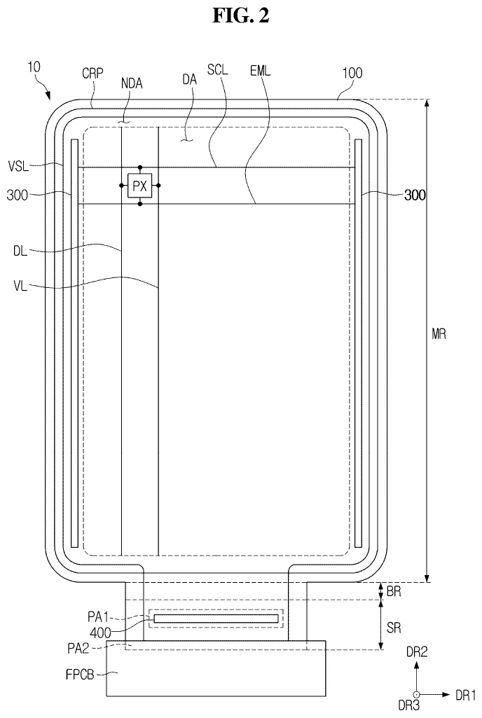

The display panel 100 may include a display area DA (see FIG. 2) and a non-display area NDA (see FIG. 2). The display area DA may include the plurality of pixels PX. The non-display area NDA may surround the display area DA and include the gate driving unit 300 and the data driving unit 400.

A plurality of gate lines GL and a plurality of data lines DL may intersect each other in the display panel 100 and may be electrically connected to each of the pixels PX. For example, one pixel PX may receive the gate signal from the gate driving unit 300 through the gate line GL, receive the data signal from the data driving unit 400 through the data line DL, and receive a driving voltage EVDD and a low-potential voltage EVSS from the power supply unit 500.

The gate line GL may include the scan line SCL and the light-emitting control line EML. The scan line SCL may supply a scan signal SC to the pixels PX, and the light-emitting control line EML may supply a light-emitting control signal EM to the pixels PX. The data line DL may supply a data voltage Vdata to the pixels PX, and a power line VL may supply a power voltage. Here, the power voltage may include the driving voltage EVDD, the low-potential voltage EVSS, an initialization voltage Vint, a reference voltage Vref, and a bias voltage Vbias, but is not limited thereto.

The display panel 100 may include a non-transmissive display panel or a transmissive display panel. The transmissive display panel may display an image on a screen and may be applied to a transparent display device in which an actual background is visible. For example, the display panel 100 may be implemented as a flexible display panel including a plastic substrate.

Touch sensors may be disposed on the display panel 100. A touch input may be sensed using separate touch sensors or sensed through the pixels PX. The touch sensors are on-cell type or add-on type touch sensors and may be implemented as an in-cell type touch sensors disposed on the screen of the display panel 100 or embedded into the display panel 100.

The controller 200 may process image data RGB input from a host system (not illustrated) to be suitable for the size and resolution of the display panel 100 and supply the processed image data RGB to the data driving unit 400. Here, the host system may be one of a TV system, a set-top box, a navigation system, a personal computer (PC), a home theater system, a mobile device, a wearable device, and a vehicle system. The controller 200 may generate a gate control signal GCS and a data control signal DCS based on synchronous signals input from the host system. Here, the synchronous signals may include a clock signal CLK, a data enable signal DEN, a horizontal synchronous signal Hsync, and a vertical synchronous signal Vsync, but are not limited thereto. The gate control signal GCS may be supplied to the gate driving unit 300 to control the operation timing of the gate driving unit 300, and the data control signal DCS may be supplied to the data driving unit 400 to control the operation timing of the data driving unit 400. For example, the controller 200 may be configured in combination with a microprocessor, a mobile processor, an application processor, etc.

The controller 200 may drive the pixels PX at various refresh rates. The controller 200 may drive the pixels PX in a variable refresh rate (VRR) mode or drive the pixels PX to be switchable between a first refresh rate and a second refresh rate. For example, the controller 200 may drive the pixel PX at various refresh rates by simply changing rates of clock signals, generating synchronization signals to generate a horizontal blank or a vertical blank, or driving the gate driving unit 300 in a mask manner.

The gate control signal GCS may be converted into voltage levels of a gate high voltage VGH and a gate low voltage VGL through a level shifter (not illustrated) and supplied to the gate driving unit 300. The level shifter may convert the high level voltage of the gate control signal GCS into the gate high voltage VGH and the low level voltage of the gate control signal GCS into the gate low voltage VGL. The gate control signal GCS may include a start pulse and a shift clock.

The gate driving unit 300 may supply the gate signal to the gate line GL based on the gate control signal GCS supplied from the controller 200. The gate driving unit 300 may include a scan driver 310 and a light-emitting control driver 320. The gate line GL may include the scan line SCL and the light-emitting control line EML. The scan driver 310 may supply the scan signal SC to the scan line SCL, and the light-emitting control driver 320 may supply the light-emitting control signal EM to the light-emitting control line EML. Each of the scan signal SC and the light-emitting control signal EM may include a pulse that swings between the gate high voltage VGH and the gate low voltage VGL. The scan signal SC may select the pixels PX of a line on which data is written in synchronization with the data voltage Vdata, and the light-emitting control signal EM may define light-emitting times of the pixels PX. The gate driving unit 300 may be disposed on one side or both sides of the display panel 100 in a gate in panel (GIP) manner. The gate driving unit 300 may shift the gate signals using the shift register and sequentially supply the shifted gate signals to the gate lines GL.

The data driving unit 400 may convert the image data RGB into the data voltage Vdata according to the data control signal DCS supplied from the controller 200 and supply the converted data voltage Vdata to the data lines DL. The number and arrangement location of the data driving unit 400 are not limited to those illustrated in FIG. 1. For example, the data driving unit 400 may be composed of a plurality of integrated circuits (ICs) and disposed separately as a plurality of data driving units on one side of the display panel 100.

The power supply unit 500 may generate direct current (DC) power required for driving the display panel 100 using a DC-DC converter. For example, the DC-DC converter may include a charge pump, a regulator, a buck converter, a boost converter, etc. The power supply unit 500 may receive a DC input voltage applied from the host system and generate a DC voltage, such as the gate high voltage VGH, the gate low voltage VGL, the driving voltage EVDD, the low-potential voltage EVSS, the initialization voltage Vint, the reference voltage Vref, and the bias voltage Vbias. The gate high voltage VGH and the gate low voltage VGL may be supplied to the level shifter and the gate driving unit 300. The driving voltage EVDD, the low-potential voltage EVSS, the initialization voltage Vint, and the reference voltage Vref may be supplied to the pixels PX.

FIG. 2 is a plan view illustrating a display device according to one embodiment.

Referring to FIG. 2, the display panel 100 may include the display area (DA) and the non-display area NDA. The flat surface shape of the display area DA may have a rectangular shape. The display area DA may have a rectangular shape with rounded corners, but is not limited thereto. As another example, the flat surface shape of the display area DA may be a square, a circle, an oval, or other polygonal shapes.

Hereinafter, a first direction DR1 and a second direction DR2 are different directions and are mutually intersecting directions and represent directions that intersect vertically in a plan view of the display device 10. The first direction DR1 may be generally the same as an extension direction of short sides of the display panel 100, and the second direction DR2 may be the same as an extension direction of long sides of the display panel 100. However, the directions described in the embodiments should be understood as indicating relative directions, and the embodiments are not limited to the described directions.

The display area DA may include short sides extending in the first direction DR1 and long sides extending in the second direction DR2. The non-display area NDA may surround the display area DA. The non-display area NDA may include a first side disposed in the first direction DR1 of the display area DA, a second side disposed in a direction opposite to the first direction DR1, a third side disposed in the second direction DR2, and a fourth side disposed in a direction opposite to the second direction DR2. Here, in the non-display area NDA, the first side may be a right side, the second side may be a left side, the third side may be an upper side, and the fourth side may be a lower side.

The scan lines SCL may extend in the first direction DR1 and may be spaced apart from each other in the second direction DR2. The scan lines SCL may sequentially supply the scan signal SC to the plurality of pixels PX.

The light-emitting control lines EML may extend in the first direction DR1 and may be spaced apart from each other in the second direction DR2. The light-emitting control lines EML may sequentially supply the light-emitting signal EM to the plurality of pixels PX.

The data lines DL may extend in the second direction DR2 and may be spaced apart from each other in the first direction DR1. The data lines DL may supply the data voltages to the pixels PX. The data voltages may determine the luminance of each of the pixels PX.

The power lines VL may extend in the second direction DR2 and may be spaced apart from each other in the first direction DR1. The power lines VL may supply the power voltages to the pixels PX. Here, the power voltage may include the driving voltage EVDD, the low-potential voltage EVSS, an initialization voltage Vint, a reference voltage Vref, and a bias voltage Vbias, but is not limited thereto.

The gate driving unit 300 may be disposed at each of the first side and the second side of the non-display area NDA. A low-potential line VSL may be disposed in the non-display area NDA to surround the gate driving unit 300 and the display area DA. For example, the low-potential line VSL may extend from a flexible film FPCB and pass through a sub-region SR and a bending region BR and may be disposed on the first to fourth sides of the non-display area NDA to surround the gate driving unit 300 and the display area DA.

The display panel 100 may include the main region MR, the bending region BR, and the sub-region SR. The main region MR may include the display area DA and the non-display area NDA. The bending region BR may be disposed between the main region MR and the sub-region SR. The bending region BR may extend from the fourth side of the non-display area NDA in the direction opposite to the second direction DR2. The sub-region SR may extend from the bending region BR in the direction opposite to the second direction DR2.

The sub-region SR may include a first pad area PA1 and a second pad area PA2. The first pad area PA1 may be disposed in a central portion of the sub-region SR and connected to the data driving unit 400. The second pad area PA2 may be disposed at an end of the sub-region SR and connected to the flexible film FPCB.

The data driving unit 400 may be formed in the form of an integrated circuit (IC). For example, the data driving unit 400 may be disposed in a chip on plastic (CIP) manner in which the data driving unit 400 is directly mounted on the display panel 100. As another example, the data driving unit 400 may be disposed in a chip on glass manner or a chip on film manner.

The display panel 100 may further include a crack sensing pattern CRP surrounding the low-potential line VSL. The crack sensing pattern CRP may be disposed on the first to fourth sides of the non-display area NDA to completely surround the display area DA. As another example, the crack sensing pattern CRP may not be disposed on a part of the non-display area NDA.

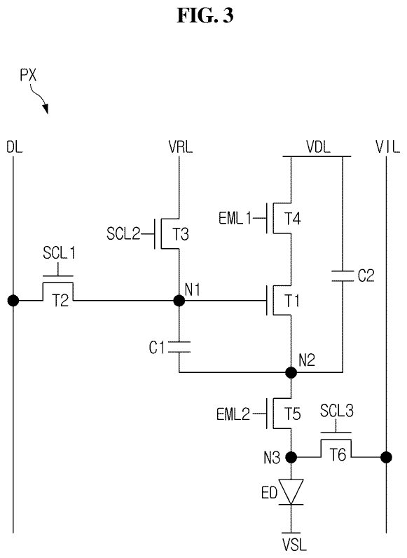

FIG. 3 is a circuit diagram illustrating a circuit of the display device according to one embodiment.

Referring to FIG. 3, each of the plurality of pixels PX may be connected to a first scan line SCL1, a second scan line SCL2, a third scan line SCL3, a first light-emitting control line EML1, a second light-emitting control line EML2, the data line DL, a reference voltage line VRL, a driving voltage line VDL, an initialization voltage line VIL, and a low-voltage line VSL.

The pixel PX may include a pixel circuit and a light-emitting element ED. The pixel circuit may include a first transistor T1, a second transistor T2, a third transistor T3, a fourth transistor T4, a fifth transistor T5, a sixth transistor T6, a first capacitor C1, and a second capacitor C2.

The first transistor T1 is a driving transistor and may include a gate electrode, a drain electrode, and a source electrode. The first transistor T1 may control a drain-source current (Ids) (or a driving current) according to the data voltage applied to the gate electrode. The driving current (Ids) flowing through a channel of the first transistor T1 may be proportional to the square of a difference between a voltage (Vgs) and a threshold voltage (Vth) between the gate electrode and the source electrode of the first transistor T1 (Ids=k×(Vgs−Vth)²). Here, k denotes a proportional coefficient determined by the structure and physical characteristics of the first transistor T1, Vgs denotes a gate-source voltage of the first transistor T1, and Vth denotes the threshold voltage of the first transistor T1. The gate electrode of the first transistor T1 may be electrically connected to a first node N1, the drain electrode may be connected to a source electrode of the fourth transistor T4, and the source electrode may be electrically connected to a second node N2.

The light-emitting element ED may receive the driving current (Ids) and emit light. The amount of light emitted or the luminance of the light-emitting element ED may be proportional to the magnitude of the driving current (Ids). The light-emitting element ED may be an organic light-emitting diode including a first electrode, a second electrode, and an organic light-emitting layer disposed between the first electrode and the second electrode, but the type of the light-emitting element ED is not limited thereto.

The first electrode of the light emitting element ED may be electrically connected to a third node N3. The first electrode of the light-emitting element ED may be connected to a source electrode of a fifth transistor T5 and a drain electrode of a sixth transistor T6 via the third node N3. Here, the first electrode of the light-emitting element ED may be an anode electrode or a pixel electrode. The second electrode of the light-emitting element ED may be electrically connected to the low-potential line VSL and may receive the low-potential voltage EVSS from the low-potential line VSL. Here, the second electrode of the light-emitting element ED may be a cathode electrode or a common electrode.

The second transistor T2 is a data transistor and may be turned on by a first scan signal of the first scan line SCL1 to electrically connect the data line DL to the first node N1, which is the gate electrode of the first transistor T1. The second transistor T2 may be turned on based on the first scan signal to supply the data voltage to the first node N1. In the second transistor T2, a gate electrode may be electrically connected to the first scan line SCL1, a drain electrode may be electrically connected to the data line DL, and a source electrode may be electrically connected to the first node N1.

The third transistor T3 is an initialization transistor and may be turned on by a second scan signal of the second scan line SCL2 to electrically connect the reference voltage line VRL to the first node N1, which is the gate electrode of the first transistor T1. The third transistor T3 may be turned on based on the second scan signal to supply the reference voltage Vref to the first node N1. In the third transistor T3, a gate electrode may be electrically connected to the second scan line SCL2, a drain electrode may be electrically connected to the reference voltage line VRL, and a source electrode may be electrically connected to the first node N1.

The fourth transistor T4 is an emission transistor and may be turned on by a first light-emitting signal of the first light-emitting control line EML1 to electrically connect the driving voltage line VDL to the drain electrode of the first transistor T1. In the fourth transistor T4, a gate electrode may be electrically connected to the first light-emitting control line EML1, a drain electrode may be electrically connected to the driving voltage line VDL, and a source electrode may be electrically connected to the drain electrode of the first transistor T1.

The fifth transistor T5 is an emission transistor and may be turned on by a second light-emitting signal of the second light-emitting control line EML2 to electrically connect the second node N2 to the third node N3. In the fifth transistor T5, a gate electrode may be electrically connected to the second light-emitting control line EML2, a drain electrode may be electrically connected to the second node N2, and a source electrode may be electrically connected to the third node N3.

The sixth transistor T6 is an initialization transistor and may be turned on by a third scan signal of the third scan line SCL3 to electrically connect the third node N3, which is the first electrode of the light-emitting element ED, to the initialization voltage line VIL. The sixth transistor T6 may be turned on based on the third scan signal to initialize the first electrode of the light-emitting element ED with the initialization voltage. In the sixth transistor T6, a gate electrode may be electrically connected to the third scan line SCL3, a drain electrode may be electrically connected to the third node N3, and a source electrode may be electrically connected to the initialization voltage line VIL.

The first to sixth transistors T1, T2, T3, T4, T5, and T6 may include an oxide-based active layer. The first to sixth transistors T1, T2, T3, T4, T5, and T6 may correspond to n-type transistors and output a current flowing into the drain electrode to the source electrode based on the gate high voltage VGH applied to the gate electrode. The oxide-based active layer may have a relatively small S-factor, increase a constant current driving area in a low-gray area, and improve low-gray expression.

As another example, at least one of the first to sixth transistors T1, T2, T3, T4, T5, and T6 may include an active layer formed of low-temperature polycrystalline silicon (LTPS). At least one of the first to sixth transistors T1, T2, T3, T4, T5, and T6 may correspond to a p-type transistor and output a current flowing into the source electrode to the drain electrode based on the gate low voltage VGL applied to the gate electrode.

The first capacitor C1 may be electrically connected to the first node N1, which is the gate electrode of the first transistor T1, and the second node N2, which is the source electrode of the first transistor T1. For example, a first capacitor electrode of the first capacitor C1 may be electrically connected to the first node N1, and a second capacitor electrode of the first capacitor C1 may be electrically connected to the second node N2, thereby maintaining a potential difference between the gate electrode and the source electrode of the first transistor T1.

The second capacitor C2 may be electrically connected to the driving voltage line VDL and the second node N2, which is the source electrode of the first transistor T1. For example, a first capacitor electrode of the second capacitor C2 may be electrically connected to the driving voltage line VDL, and a second capacitor electrode of the second capacitor C2 may be electrically connected to the second node N2, thereby maintaining a potential difference between the driving voltage line VDL and the source electrode of the first transistor T1.

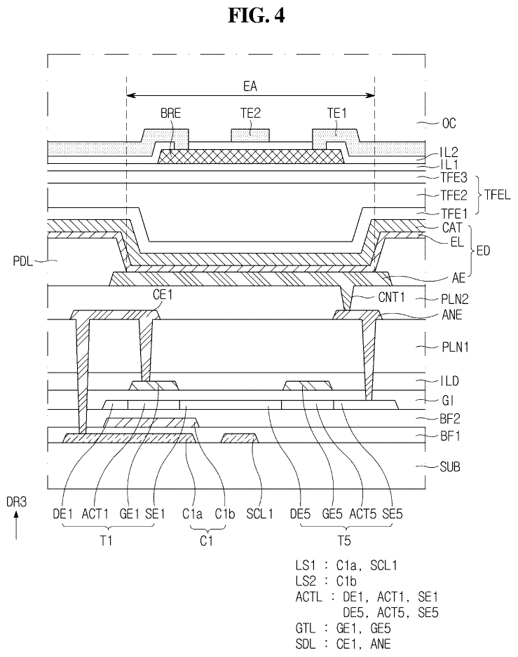

FIG. 4 is a cross-sectional view illustrating the circuit of the display device according to one embodiment.

Referring to FIG. 4, the display panel 100 may include a substrate SUB, a first light-blocking layer LS1, a first buffer layer BF1, a second light-blocking layer LS2, a second buffer layer BF2, an active layer ACTL, a gate insulating layer GI, a gate layer GTL, an interlayer insulating layer ILD, a first protective layer PLN1, a source metal layer SDL, a second protective layer PLN2, a light-emitting element ED, a pixel defining layer PDL, an encapsulation layer TFEL, a first insulating layer IL1, a bridge electrode BRE, a second insulating layer IL2, a first touch electrode TE1, a second touch electrode TE2, and a planarization layer OC.

The substrate SUB may be a base substrate or a base member. The substrate SUB may include at least one plastic material. For example, the substrate SUB may be a multi-substrate including a plurality of plastic materials, such as polyimide, but a constituent material of the substrate SUB is not limited thereto.

The first light-blocking layer LS1 may be disposed on the substrate SUB. The first light-blocking layer LS1 may include a first capacitor electrode C1a of the first capacitor C1 and the first scan line SCL1. The first capacitor electrode C1a may be disposed below the first transistor T1 to block light incident on the first transistor T1. Thus, the first capacitor electrode C1a overlaps the first transistor T1 to block light. The first capacitor electrode C1a may generate capacitance by overlapping the second capacitor electrode C1b in the third direction DR3 or a thickness of the substrate SUB. The first scan line SCL1 may supply the first scan signal to the second transistor T2 illustrated in FIG. 3. The first scan line SCL1 is on the same layer as the first capacitor electrode C1a. In one embodiment, at least a portion of the first scan line SCL1 is non-overlapping with the second capacitor electrode C1b. The first light-blocking layer LS1 may be formed of a single layer or multiple layers formed of one of molybdenum (Mo), aluminum (Al), chromium (Cr), gold (Au), titanium (Ti), nickel (Ni), neodymium (Nd), and copper (Cu), or an alloy thereof, but is not limited thereto.

The first buffer layer BF1 may be disposed on the first light-blocking layer LS1. For example, the first buffer layer BF1 covers the first scan line SCL1 and the first capacitor electrode C1a. The first buffer layer BF1 may include an inorganic film capable of preventing or at least reducing the penetration of air or moisture. For example, the first buffer layer BF1 may include a plurality of inorganic films alternately stacked.

The second light-blocking layer LS2 may be disposed on the first buffer layer BF1. The second light-blocking layer LS2 may include the second capacitor electrode C1b of the first capacitor C1. The second capacitor electrode C1b may be disposed below the first transistor T1 to block light incident on the first transistor T1. For example, the second light-blocking layer LS2 that includes the second capacitor electrode C1b is between the first light-blocking layer LS1 and the first transistor T1. The second capacitor electrode C1b may generate capacitance by overlapping the first capacitor electrode C1a. The second light-blocking layer LS2 may include a material exemplified in the first light-blocking layer LS1, but is not limited thereto.

The second buffer layer BF2 may be disposed on the second light-blocking layer LS2. Thus, the second buffer layer BF2 covers the second light-blocking layer LS2 including the second capacitor electrode C1b. The second buffer layer BF2 may include an inorganic film capable of preventing or at least reducing the penetration of air or moisture. For example, the second buffer layer BF2 may include a plurality of inorganic films alternately stacked.

The active layer ACTL may be disposed on the second buffer layer BF2. The active layer ACTL may include an oxide-based material, but is not limited thereto. The active layer ACTL may include a semiconductor area ACT1 (e.g., a first semiconductor area), a drain electrode DE1, a source electrode SE1 of the first transistor T1, and a semiconductor area ACT5 (e.g., a second semiconductor area), a drain electrode DE5, and a source electrode SE5 of the fifth transistor T5. The source electrode SE1 of the first transistor T1 and the drain electrode DE5 of the fifth transistor T5 may be integrally formed. Thus, the source electrode SE1 of the first transistor T1 and the drain electrode DE5 of the fifth transistor T5 are integral with each other. In one embodiment, the drain electrode DEI of the first transistor T1 is at a first side of the semiconductor area ACT1 and the source electrode SE1 of the first transistor T1 is at a second side of the semiconductor area ACT1. Similarly, the drain electrode DE5 of the fifth transistor T5 is at a first side of the semiconductor area ACT5 and the source electrode SE5 of the fifth transistor T5 is at a second side of the semiconductor area ACT5.

The gate insulating layer GI may be disposed on the active layer ACTL. The gate insulating layer GI may insulate the active layer ACTL and the gate layer GTL.

The gate layer GTL may be disposed on the gate insulating layer GI. The gate layer GTL may include a gate electrode GE1 of the first transistor T1 and a gate electrode GE5 of the fifth transistor T5. The gate electrode GE5 of the fifth transistor T5 may be a part of the second light-emitting control line EML2 illustrated in FIG. 3.

The interlayer insulating layer ILD may be disposed on the gate layer GTL. The interlayer insulating layer ILD may insulate the gate layer GTL and the source metal layer SDL.

The first protective layer PLN1 may be disposed on the interlayer insulating layer ILD. The first protective layer PLN1 may planarize the upper portions of the transistors and protect the transistors. The first protective layer PLN1 may include an organic material. For example, the first protective layer PLN1 may include an acrylic resin, an epoxy resin, a phenolic resin, a polyamide resin, or a polyimide resin, but is not limited thereto.

The source metal layer SDL may be disposed on the first protective layer PLN1. The source metal layer SDL may include a first connection electrode CE1 and an anode connection electrode ANE. The first connection electrode CE1 may electrically connect the gate electrode GE1 of the first transistor T1 and the first capacitor electrode C1a of the first capacitor C1. The first connection electrode CE1 may be inserted into a contact hole passing through the first protective layer PLN1 and the interlayer insulating layer ILD to be in contact with the gate electrode GE1 of the first transistor T1. The first connection electrode CE1 may be inserted into a contact hole passing through the first protective layer PLN1, the interlayer insulating layer ILD, the gate insulating layer GI, the second buffer layer BF2, and the first buffer layer BF1 to be in contact with the first capacitor electrode C1a.

The anode connection electrode ANE may electrically connect the source electrode SE5 to the pixel electrode AE of the fifth transistor T5. The anode connection electrode ANE may be inserted into the contact hole passing through the first protective layer PLN1, the interlayer insulating layer ILD, and the gate insulating layer GI to be in contact with the source electrode SE5 of the fifth transistor T5.

The second protective layer PLN2 may be disposed on the source metal layer SDL. The second protective layer PLN2 may planarize the upper portion of the source metal layer SDL and protect the source metal layer SDL. The second protective layer PLN2 may include an organic material. For example, the second protective layer PLN2 may include the material exemplified in the first protective layer PLN1, but is not limited thereto.

The pixel defining layer PDL may be disposed on the second protective layer PLN2. The pixel defining layer PDL may define the light-emitting area EA or the opening area. The pixel defining layer PDL may include a material including a black pigment, etc., an organic material, such as a benzocyclobutene resin, a polyimide resin, an acrylic resin, a photosensitive polymer, etc., but is not limited thereto. When the pixel defining layer PDL includes a material including a black pigment, a black dye, etc., the pixel defining layer PDL may be a black bank. The pixel defining layer PDL may include a black pigment or a black dye, thereby blocking external light and increasing the luminance of the display device 10.

Optionally, a spacer (not illustrated) may be disposed on the pixel defining layer PDL. The spacer may include the same material as the pixel defining layer PDL, but is not limited thereto.

The light-emitting element ED may include a pixel electrode AE, a light-emitting layer EL, and a common electrode CAT. The pixel electrode AE may be disposed on the second protective layer PLN2. The pixel electrode AE may overlap one of a plurality of light-emitting areas EA defined by the pixel defining layer PDL. The pixel electrode AE may receive a driving current from a pixel circuit of the pixel PX. The pixel electrode AE may be a first electrode of the light-emitting element ED of FIG. 3.

The light-emitting layer EL may be disposed on the pixel electrode AE. For example, the light-emitting layer EL may be an organic light-emitting layer formed of an organic material, but is not limited thereto. When the light-emitting layer EL corresponds to an organic light-emitting layer, when the pixel circuit of the pixel PX applies a predetermined voltage to the pixel electrode AE and the common electrode CAT receives the common voltage or the cathode voltage, holes may move to the light-emitting layer EL through the hole transporting layer, electrons may move to the light-emitting layer EL through the electron transporting layer, and the holes and electrons may be combined in the light-emitting layer EL to emit light.

The common electrode CAT may be disposed on the light-emitting layer EL. For example, the common electrode CAT may be implemented in the form of an electrode that is common to all pixels PX without being distinguished by each pixel PX. The common electrode CAT may be a transparent electrode and may transmit light. The common electrode CAT may be electrically connected to the low-potential line VSL and may receive a low-potential voltage, a common voltage, or a cathode voltage. The common electrode CAT may be a second electrode of the light-emitting element ED of FIG. 3.

The encapsulation layer TFEL may be disposed on the light-emitting element ED. The encapsulation layer TFEL may be disposed on the common electrode CAT to cover a plurality of light-emitting elements ED. The encapsulation layer TFEL may include a first encapsulation layer TFE1, a second encapsulation layer TFE2, and a third encapsulation layer TFE3 sequentially stacked on the common electrode CAT.

The first encapsulation layer TFE1 may be disposed on the common electrode CAT. The first encapsulation layer TFE1 may include an inorganic material to prevent or at least reduce oxygen or moisture from penetrating the light-emitting element ED. For example, the first encapsulation layer TFE1 may include at least one of a silicon nitride layer, a silicon oxynitride layer, a silicon oxide layer, a titanium oxide layer, an aluminum oxide layer, and an amorphous silicon layer, but is not limited thereto.

The second encapsulation layer TFE2 may be disposed on the first encapsulation layer TFE1 to planarize upper ends of the plurality of light-emitting elements ED. The second encapsulation layer TFE2 may include an organic material to protect the light-emitting element ED from foreign substances, such as dust. For example, the second encapsulation layer TFE2 may include an organic film, such as an acrylic resin, an epoxy resin, a phenolic resin, a polyamide resin, a polyimide resin, etc. The second encapsulation layer TFE2 may be formed by curing a monomer or coating a polymer.

The third encapsulation layer TFE3 may be disposed on the second encapsulation layer TFE2. The third encapsulation layer TFE3 may include an inorganic material to prevent oxygen or moisture from penetrating the light-emitting element ED. For example, the third protective layer TFE3 may include the material exemplified in the first encapsulation layer TFE1, but is not limited thereto.

The first insulating layer IL1 may be disposed on the encapsulation layer TFEL. The first insulating layer IL1 may have an insulating and optical function. The first insulating layer IL1 may include at least one inorganic film.

The bridge electrode BRE may be disposed on the first insulating layer IL1. The bridge electrode BRE may be disposed on a different layer from the first and second touch electrodes TE1 and TE2 to electrically connect the first touch electrodes TE1 spaced apart from each other with the second touch electrode TE2 interposed therebetween.

The second insulating layer IL2 may be disposed on the bridge electrode BRE. The second insulating layer IL2 may insulate the bridge electrode BRE and the first and second touch electrodes TE1 and TE2. The second insulating layer IL2 may include at least one inorganic film.

The first touch electrode TEL and the second touch electrode TE2 may be disposed on the second insulating layer IL2. The first and second touch electrodes TE1 and TE2 may be formed of a single layer of molybdenum (Mo), titanium (Ti), copper (Cu), aluminum (Al), and indium tin oxide (ITO) or formed of a stacked structure of aluminum and titanium (Ti/Al/Ti), a stacked structure of aluminum and ITO (ITO/AI/ITO), an APC alloy, and a stacked structure of APC alloy and ITO (ITO/APC/ITO). A touch driving unit (not illustrated) may determine whether a touch input has occurred based on a change in capacitance between the first and second touch electrodes TE1 and TE2 and calculate touch input coordinates.

The planarization layer OC may be disposed on the first and second touch electrodes TE1 and TE2. The planarization layer OC may planarize upper portions of the first and second touch electrodes TE1 and TE2 and protect the first and second touch electrodes TE1 and TE2. The planarization layer OC may include an organic insulation material.

The display device 10 may include one source metal layer SDL between the transistors of the pixel circuit and the pixel electrode AE of the light-emitting element ED, thereby reducing the number of masks in the manufacturing process and the manufacturing cost. The display device 10 may reduce the number of conductive layers, thereby optimizing the process and shortening the manufacturing period.

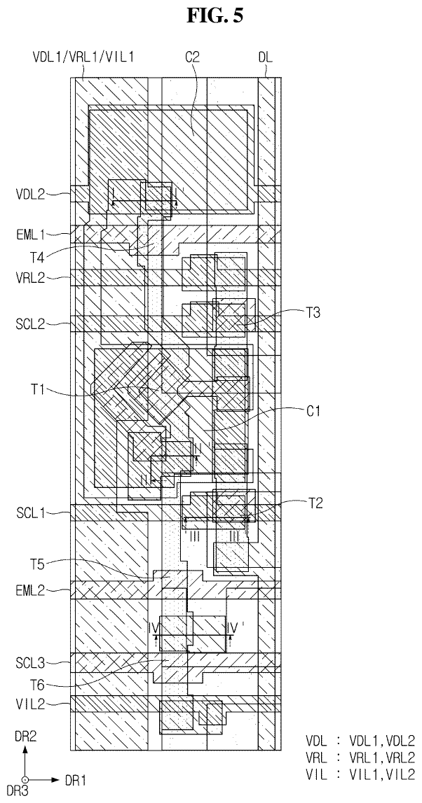

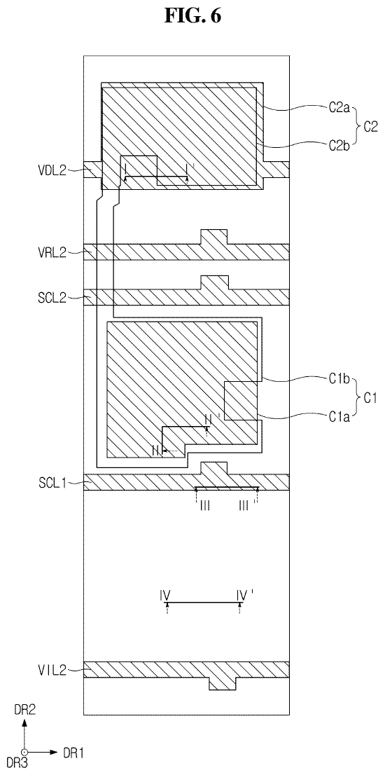

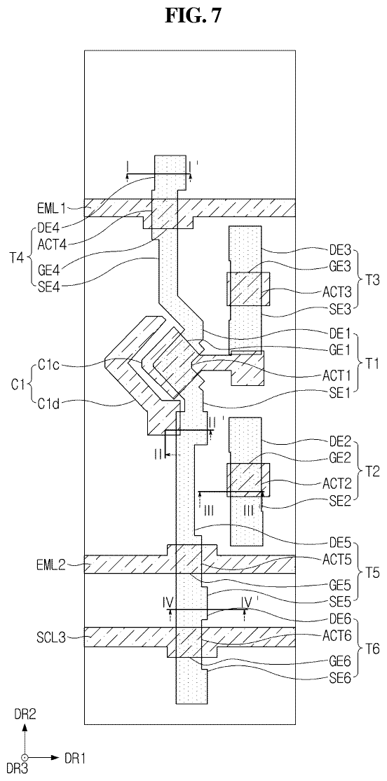

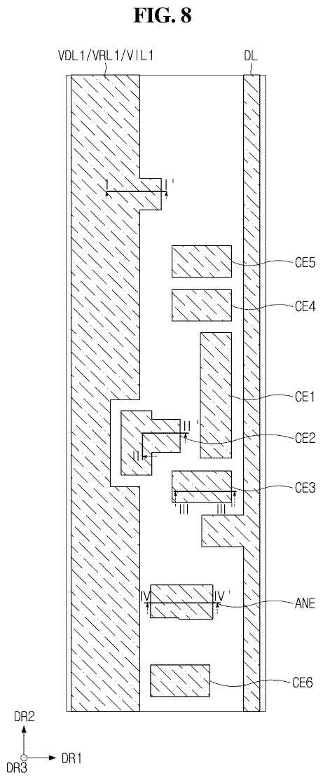

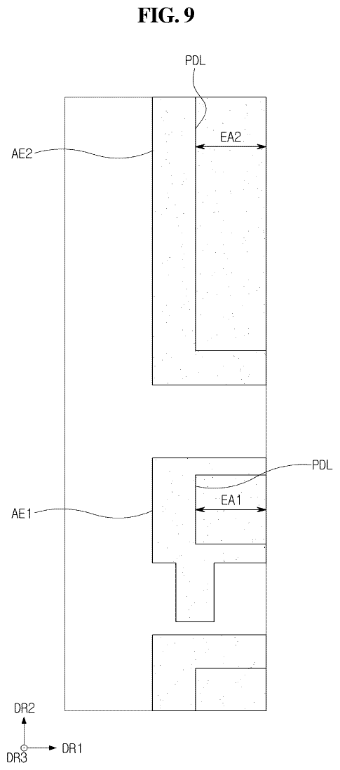

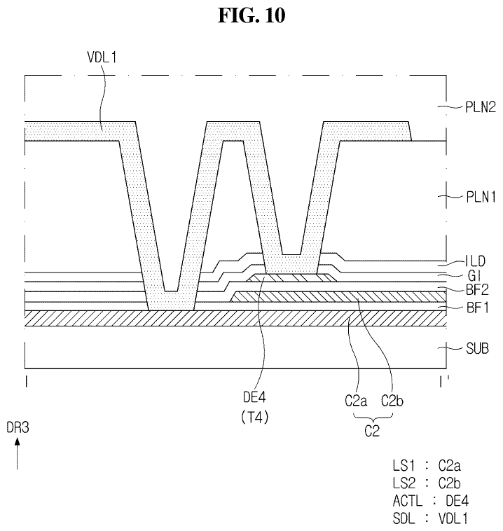

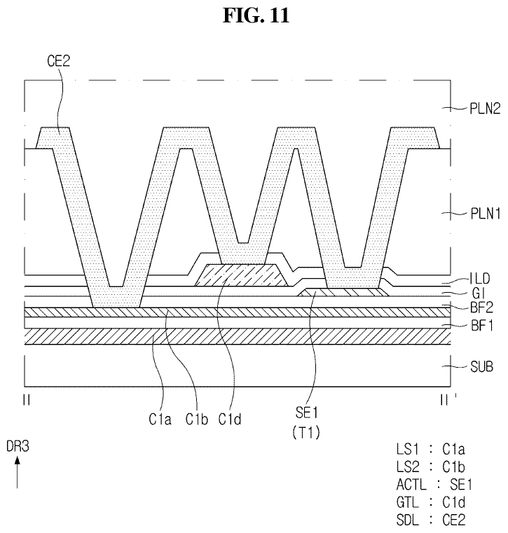

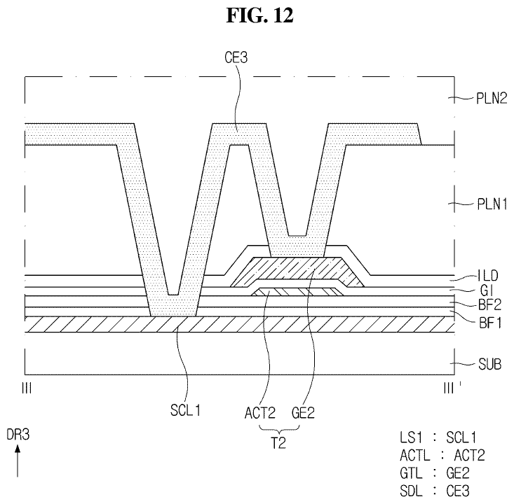

FIG. 5 is a layout view illustrating a pixel of the display device according to one embodiment. FIG. 6 is a view illustrating some layers of the layout view of FIG. 5 and illustrates the stacked structure of the first and second light-blocking layers LS1 and LS2 according to one embodiment. FIG. 7 is a view illustrating other layers of the layout view of FIG. 5 and illustrates the stacked structure of the active layer ACTL and the gate layer GTL according to one embodiment. FIG. 8 is a view illustrating other layers of the layout view of FIG. 5 and illustrates the source metal layer SDL according to one embodiment. FIG. 9 is a view illustrating other layers of the layout view of FIG. 5 and illustrates the stacked structure of the first and second pixel electrodes AE1 and AE2 and the pixel defining layer PDL according to one embodiment. FIG. 10 is a cross-sectional view along lines I-I′ in FIGS. 5 to 8 according to one embodiment, and FIG. 11 is a cross-sectional view along lines II-II′ in FIGS. 5 to 8 according to one embodiment. FIG. 12 is a cross-sectional view along lines III-III′ in FIGS. 5 to 8, and FIG. 13 is a cross-sectional view along lines IV-IV′ in FIGS. 5 to 8 according to one embodiment.

Referring to FIGS. 5 to 13, the plurality of pixels PX may be disposed in a plurality of rows and a plurality of columns. Each of the plurality of pixels PX may be connected to the first scan line SCL1, the second scan line SCL2, the third scan line SCL3, the first light-emitting control line EML1, the second light-emitting control line EML2, the data line DL, the reference voltage line VRL, the driving voltage line VDL, the initialization voltage line VIL, and the low-voltage line VSL.

The driving voltage line VDL may include first and second driving voltage lines VDL1 and VDL2. In FIGS. 5 and 8, the first driving voltage line VDL1 may extend from the source metal layer SDL in the second direction DR2. The first driving voltage line VDL1 may supply the driving voltage EVDD received from the power supply unit 500 to the pixel PX. In FIG. 10, the first driving voltage line VDL1 may be inserted into a contact hole passing through the first protective layer PLN1, the interlayer insulating layer ILD, the gate insulating layer GI, the second buffer layer BF2, and the first buffer layer BF1 and connected to the first capacitor electrode C2a of the second capacitor C2, which is a part of the second driving voltage line VDL2. The first driving voltage line VDL1 may be inserted into a contact hole passing through the first protective layer PLN1, the interlayer insulating layer ILD, and the gate insulating layer GI and connected to a drain electrode DE4 of the fourth transistor T4.

The first driving voltage line VDL1, the first reference voltage line VRL1, and the first initialization voltage line VIL1 may be alternately disposed among a plurality of columns of the pixels PX. For example, the first driving voltage line VDL1 may be disposed in some columns of pixels PX, the first reference voltage line VRL1 may be disposed in other columns of pixels PX, and the first initialization voltage line VIL1 may be disposed in other columns of pixels PX. The cross-sectional view of FIG. 10 discloses a configuration in which the first driving voltage line VDL1 is connected to the second driving voltage line VDL2, but when the first reference voltage line VRL1 or the first initialization voltage line VIL1 is disposed at the corresponding location, the first reference voltage line VRL1 or the first initialization voltage line VIL1 may not be connected to the second driving voltage line VDL2.

In FIGS. 5 and 6, the second driving voltage line VDL2 may extend from the first light-blocking layer LS1 in the first direction DR1. The second driving voltage line VDL2 may be connected to the first driving voltage line VDL1 to receive the driving voltage EVDD and supply the driving voltage EVDD to the pixel PX. The second driving voltage line VDL2 may include the first capacitor electrode C2a of the second capacitor C2. In FIG. 10, the first capacitor electrode C2a of the second capacitor C2 may overlap the second capacitor electrode C2b in the third direction DR3 to generate capacitance. The second capacitor electrode C2b of the second capacitor C2 may be disposed in the second light-blocking layer LS2 and formed integrally with the second capacitor electrode C1b of the first capacitor C1.

The reference voltage line VRL may include the first and second reference voltage lines VRL1 and VRL2. In FIGS. 5 and 8, the first reference voltage line VRL1 may extend from the source metal layer SDL in the second direction DR2. The first reference voltage line VRL1 may supply the reference voltage Vref received from the power supply unit 500 to the pixel PX.

In FIGS. 5 and 6, the second reference voltage line VRL2 may extend from the first light-blocking layer LS1 in the first direction DR1. The second reference voltage line VRL2 may be connected to the first reference voltage line VRL1 to receive the reference voltage Vref and supply the reference voltage Vref to the pixel PX. The second reference voltage line VRL2 may be electrically connected to the drain electrode DE3 of the third transistor T3 through the fifth connection electrode CE5 disposed on the source metal layer SDL.

The initialization voltage line VIL may include a first initialization voltage line VIL1 and a second initialization voltage line VIL2. In FIGS. 5 and 8, the first initialization voltage line VIL1 may extend from the source metal layer SDL in the second direction DR2. The initialization voltage line VIL may supply the initialization voltage Vint received from the power supply unit 500 to the pixel PX.

In FIGS. 5 and 6, the second reference voltage line VIL2 may extend from the first light-blocking layer LS1 in the first direction DR1. The second initialization voltage line VIL2 may be connected to the first initialization voltage line VIL1 to receive the initialization voltage Vint and supply the initialization voltage Vint to the pixel PX. The second reference voltage line VIL2 may be electrically connected to a drain electrode SE6 of the third transistor T6 through a fifth connection electrode CE6 disposed on the source metal layer SDL.

The first transistor T1 may include the semiconductor area ACT1, the drain electrode DE1, the source electrode SE1, and the gate electrode GE1. The semiconductor area ACT1, the drain electrode DE1, and the source electrode SE1 of the first transistor T1 may be disposed on the active layer ACTL, and the gate electrode GE1 of the first transistor T1 may be disposed on the gate layer GTL. The gate electrode GE1 of the first transistor T1 may overlap the semiconductor area ACT1 of the first transistor T1. For example, the semiconductor area ACT1 of the first transistor T1 may include an oxide, and the drain electrode DE1 and the source electrode SE1 of the first transistor T1 may be formed by being N-type doped.

The gate electrode GE1 of the first transistor T1 may be a part of a third capacitor electrode C1c of the first capacitor C1. The third capacitor electrode C1c of the first capacitor C1 may be electrically connected to the first capacitor electrode C1a of the first capacitor C1 of the first light-blocking layer LS1 through the first connection electrode CE1 of the source metal layer SDL. The first connection electrode CE1 may electrically connect a source electrode SE3 of the third transistor T3, the third capacitor electrode C1c of the first capacitor C1, the first capacitor electrode C1a of the first capacitor C1, and a source electrode SE2 of the second transistor T2.

A fourth capacitor electrode C1d of the first capacitor C1 may be disposed in the gate layer GTL to face the third capacitor electrode C1c of the first capacitor C1. The third and fourth capacitor electrodes C1c and C1d of the first capacitor C1 may be formed on the same layer to generate capacitance. In FIG. 11, the fourth capacitor electrode C1d of the first capacitor C1 may be electrically connected to the second capacitor electrode C1b of the first capacitor C1 through the second connection electrode CE2 of the source metal layer SDL. The second connection electrode CE2 may electrically connect the fourth capacitor electrode C1d of the first capacitor C1, the second capacitor electrode C1b of the first capacitor C1, and the source electrode SE1 of the first transistor T1.

The first and second capacitor electrodes C1a and C1b of the first capacitor C1 may overlap in the third direction DR3 to generate capacitance, and the third and fourth capacitor electrodes C1c and C1d may overlap in the first direction DR1 to generate capacitance. Accordingly, the first capacitor C1 may be formed in a double layer to secure capacitance capacity and reduce coupling capacitance between pixel circuits.

The drain electrode DE1 of the first transistor T1 may be formed integrally with a source electrode SE4 of the fourth transistor T4. The source electrode SE1 of the first transistor T1 and the drain electrode DE5 of the fifth transistor T5 may be integrally formed. Thus, the source electrode SE1 of the first transistor T1 and the drain electrode DE5 of the fifth transistor T5 are integral with each other. In FIG. 11 fourth capacitor electrode SE1 of the first capacitor C1 may be electrically connected to the second capacitor electrode C1b, the C1b of the first capacitor C1 through the second connection electrode CE2 of the source metal layer

The second transistor T2 may include a semiconductor area ACT2, a drain electrode DE2, a source electrode SE2, and a gate electrode GE2. The semiconductor area ACT2, the drain electrode DE2, and the source electrode SE2 of the first transistor T2 may be disposed on the active layer ACTL, and the gate electrode GE2 of the first transistor T2 may be disposed on the gate layer GTL. The gate electrode GE2 of the second transistor T2 may overlap the semiconductor area ACT2 of the second transistor T2. For example, the semiconductor area ACT2 of the second transistor T2 may include an oxide, and the drain electrode DE2 and the source electrode SE2 of the second transistor T2 may be formed by being N-type doped.

In FIG. 12, the gate electrode GE2 of the second transistor T2 may be electrically connected to the first scan line SCL1 of the first light-blocking layer LS1 through the third connection electrode CE3 disposed on the source metal layer SDL. The gate electrode GE2 of the second transistor T2 may receive the first scan signal from the first scan line SCL1. The drain electrode DE2 of the second transistor T2 may receive a data voltage from the data line DL. The data line DL may be disposed on the source metal layer SDL and may extend in the second direction DR2. The source electrode SE2 of the second transistor T2 may be electrically connected to the first capacitor electrode C1a of the first capacitor C1, the third capacitor electrode C1c of the first capacitor C1, and the source electrode SE3 of the third transistor T3 through the first connection electrode CE1.

The third transistor T3 may include a semiconductor area ACT3, a drain electrode DE3, a source electrode SE3, and a gate electrode GE3. The semiconductor area ACT3, the drain electrode DE3, and the source electrode SE3 of the third transistor T3 may be disposed on the active layer ACTL, and the gate electrode GE3 of the third transistor T3 may be disposed on the gate layer GTL. The gate electrode GE3 of the third transistor T3 may overlap the semiconductor area ACT3 of the third transistor T3. For example, the semiconductor area ACT3 of the third transistor T3 may include an oxide, and the drain electrode DE3 and the source electrode SE3 of the third transistor T3 may be formed by being N-type doped.

The gate electrode GE3 of the third transistor T3 may be electrically connected to the second scan line SCL2 of the first light-blocking layer LS1 through a fourth connection electrode CE4 disposed on the source metal layer SDL. The gate electrode GE3 of the third transistor T3 may receive the second scan signal from the second scan line SCL2. The gate electrode DE3 of the third transistor T3 may be electrically connected to the second reference voltage line VRL2 of the first light-blocking layer LS1 through a fifth connection electrode CE5 disposed on the source metal layer SDL. The drain electrode DE3 of the third transistor T3 may receive the reference voltage Vref from the second reference voltage line VRL2. The source electrode SE3 of the third transistor T3 may be electrically connected to the first capacitor electrode C1a of the first capacitor C1, the third capacitor electrode C1c of the first capacitor C1, and the source electrode SE2 of the second transistor T2 through the first connection electrode CE1.

The fourth transistor T4 may include a semiconductor area ACT4, a drain electrode DE4, a source electrode SE4, and a gate electrode GE4. The semiconductor area ACT4, the drain electrode DE4, and the source electrode SE4 of the fourth transistor T4 may be disposed on the active layer ACTL, and the gate electrode GE4 of the fourth transistor T4 may be disposed on the gate layer GTL. The gate electrode GEA of the fourth transistor T4 may overlap the semiconductor area ACT4 of the fourth transistor T4. For example, the semiconductor area ACT4 of the fourth transistor T4 may include an oxide, and the drain electrode DE4 and the source electrode SE4 of the fourth transistor T4 may be formed by being N-type doped.

The gate electrode GE4 of the fourth transistor T4 may be a part of the first light-emitting control line EML1. The first light-emitting control line EML1 may be disposed in the gate layer GTL and may extend in the first direction DR1. The gate electrode GE4 of the fourth transistor T4 may receive a first light-emitting signal from the first light-emitting control line EML1. The drain electrode DE4 of the fourth transistor T4 may receive the driving voltage EVDD from the first driving voltage line VDL1 disposed in the source metal layer SDL. The source electrode SE4 of the fourth transistor T4 and the drain electrode DE1 of the first transistor T1 may be integrally formed. Thus, the source electrode SE4 of the fourth transistor T4 and the drain electrode DEI of the first transistor T1 are integral with each other.

The fifth transistor T5 may include a semiconductor area ACT5, a drain electrode DE5, a source electrode SE5, and a gate electrode GE5. The semiconductor area ACT5, the drain electrode DE5, and the source electrode SE5 of the fifth transistor T5 may be disposed on the active layer ACTL, and the gate electrode GE5 of the fifth transistor T5 may be disposed on the gate layer GTL. The gate electrode GE5 of the fifth transistor T5 may overlap the semiconductor area ACT5 of the fifth transistor T5. For example, the semiconductor area ACT5 of the fifth transistor T5 may include an oxide, and the drain electrode DE5 and the source electrode SE5 of the fifth transistor T5 may be formed by being N-type doped.

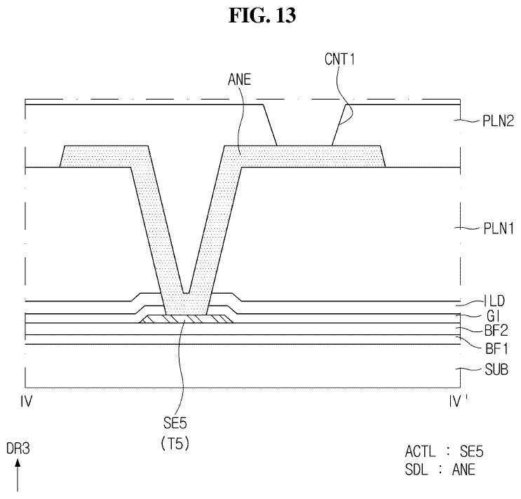

The gate electrode GE5 of the fifth transistor T5 may be a part of the second light-emitting control line EML2. The second light-emitting control line EML2 may be disposed in the gate layer GTL and may extend in the first direction DR1. The gate electrode GE5 of the fifth transistor T5 may receive the second light-emitting signal from the second light-emitting control line EML2. The drain electrode DE5 of the fifth transistor T5 may be formed integrally with the source electrode SE1 of the first transistor T1. The source electrode SE5 of the fifth transistor T5 and a drain electrode DE6 of the sixth transistor T6 may be integrally formed. Thus, the source electrode SE5 of the fifth transistor T5 and a drain electrode DE6 of the sixth transistor T6 are integral with each other. In FIG. 13, the source electrode SE5 of the fifth transistor T5 may be electrically connected to the first pixel electrode AE1 of FIG. 9 through the anode connection electrode ANE of the source metal layer SDL. The first pixel electrode AE1 may be inserted into a first contact hole CNT1 passing through the second protective layer PLN2 to be in contact with the anode connection electrode ANE. The light-emitting element ED including the first pixel electrode AE1 may emit light through the first light-emitting area EA1 defined by the pixel defining layer PDL.

In FIG. 9, the second pixel electrode AE2 may be electrically connected to the pixel circuit disposed in the second direction DR2 of the pixel circuit illustrated in FIGS. 5 to 8. The light-emitting element ED including the second pixel electrode AE2 may emit light through the second light-emitting area EA2 defined by the pixel defining layer PDL.

The sixth transistor T6 may include a semiconductor area ACT6, the drain electrode DE6, a source electrode SE6, and a gate electrode GE6. The semiconductor area ACT6, the drain electrode DE6, and the source electrode SE6 of the sixth transistor T6 may be disposed on the active layer ACTL, and the gate electrode GE6 of the sixth transistor T6 may be disposed on the gate layer GTL. The gate electrode GE6 of the sixth transistor T6 may overlap the semiconductor area ACT6 of the sixth transistor T6. For example, the semiconductor area ACT6 of the sixth transistor T6 may include an oxide, and the drain electrode DE6 and the source electrode SE6 of the sixth transistor T6 may be formed by being N-type doped.

The gate electrode GE6 of the sixth transistor T6 may be a part of the third scan line SCL3. The third scan line SCL3 may be disposed on the gate layer GTL and may extend in the first direction DR1. The gate electrode GE6 of the sixth transistor T6 may receive the third scan signal from the third scan line SCL3. The drain electrode DE6 of the sixth transistor T6 may be formed integrally with the source electrode SE5 of the fifth transistor T5. The gate electrode SE6 of the sixth transistor T6 may be electrically connected to the second initialization voltage line VIL2 of the first light-blocking layer LS1 through a sixth connection electrode CE6 disposed on the source metal layer SDL. The source electrode SE6 of the sixth transistor T6 may receive the initialization voltage Vint from the second initialization voltage line VIL2.

The display device 10 according to various embodiments of the present specification may be described as follows.

In one embodiment, a display device comprises: a substrate; a first light-blocking layer on the substrate, the first light-blocking layer including a first scan line extending in a first direction; an active layer including a semiconductor area of a first transistor, the active layer on the first light-blocking layer, a gate layer including a gate electrode of the first transistor, the gate layer on the active layer; a second transistor that receives a first scan signal from the first scan line and supplies a data voltage to the gate electrode of the first transistor, a source metal layer on the gate layer, the source metal layer including an anode connection electrode that is directly connected to the active layer and receives a driving current flowing in the first transistor, a pixel electrode on the source metal layer, the pixel electrode directly connected to the anode connection electrode; a light-emitting layer on the pixel electrode; and a common electrode on the light-emitting layer.

In one embodiment, the display device further comprises: a data line that supplies the data voltage, the data line on the source metal layer and extending in a second direction that intersects the first direction.

In one embodiment, the display device further comprises: a second scan line in the first light-blocking layer, the second scan line extending in the first direction; and a third transistor that receives a second scan signal from the second scan line and supplies a reference voltage to the gate electrode of the first transistor.

In one embodiment, the display device further comprises: a first reference voltage line that supplies the reference voltage to the third transistor, the first reference voltage line in the source metal layer and extending in a second direction that intersects the first direction; and a second reference voltage line that is electrically connected to the first reference voltage line, the second reference voltage line in the first light-blocking layer and extending in the second direction.

In one embodiment, the display device further comprises: a first light-emitting control line in the gate layer, the first light-emitting control line extending in the first direction; and a fourth transistor that receives a first light-emitting signal from the first light-emitting control line and supplies a driving voltage to a drain electrode of the first transistor.

In one embodiment, the display device further comprises: a first driving voltage line that supplies the driving voltage, the first driving voltage line in the source metal layer and extending in a second direction that intersects the first direction; and a second driving voltage line electrically connected to the first driving voltage line, the second driving voltage line in the first light-blocking layer and extending in the second direction.

In one embodiment, the display device further comprises: a second light-emitting control line in the gate layer, the second light-emitting control line extending in the first direction; and a fifth transistor that receives a second light-emitting signal from the second light-emitting control line, the fifth transistor electrically connecting a source electrode of the first transistor to the pixel electrode.

In one embodiment, the display device further comprises: a third scan line in the gate layer, the third scan line extending in the first direction; and a sixth transistor that receives a third scan signal from the third scan line and supplies an initialization voltage to the pixel electrode.

In one embodiment, the display device further comprises: a first initialization voltage line that supplies the initialization voltage to the sixth transistor, the first initialization voltage line in the source metal layer and extending in a second direction that intersects the first direction; and a second initialization voltage line that is electrically connected to the first initialization voltage line, the second initialization voltage line in the first light-blocking layer and extending in the second direction.

In one embodiment, the display device further comprises: a second light-blocking layer between the first light-blocking layer and the active layer; and a first capacitor connected to the gate electrode of the first transistor and a source electrode of the first transistor, the first capacitor including a first capacitor electrode that is electrically connected to the gate electrode of the first transistor and is in the first light-blocking layer, and a second capacitor electrode that is electrically connected to the source electrode of the first transistor and is in the second light-blocking layer.

In one embodiment, the first capacitor electrode and the second capacitor electrode of the first capacitor overlap the semiconductor area of the first transistor.

In one embodiment, the first capacitor further includes: a third capacitor electrode electrically connected to the first capacitor electrode, the third capacitor electrode in the gate layer and including the gate electrode of the first transistor, and a fourth capacitor electrode electrically connected to the second capacitor electrode, the fourth capacitor electrode in the gate layer and facing the third capacitor electrode.

In one embodiment, the display device further comprises: a second capacitor connected to a driving voltage line that supplies a driving voltage and the source electrode of the first transistor, the second capacitor including a first capacitor electrode that is in the first light-blocking layer and electrically connected to the driving voltage line, and a second capacitor electrode that is in the second light-blocking layer and electrically connected to the source electrode of the first transistor.

In one embodiment, the second capacitor electrode of the first capacitor and the second capacitor electrode of the second capacitor are integral with each other.

In one embodiment, the display device further comprises: a second light-emitting control line that supplies a second light-emitting signal, the second light-emitting control line in the gate layer and extending in the first direction; a fifth transistor that receives the second light-emitting signal, the fifth transistor connected to a source electrode of the first transistor; a source metal layer on the gate layer, the source metal layer including an anode connection electrode that is directly connected to a source electrode of the fifth transistor; and a pixel electrode on the source metal layer, the pixel electrode directly connected to the anode connection electrode.

In one embodiment, the display device further comprises: a third scan line that supplies a third scan signal, the third scan line in the gate layer and extending in the first direction; and a sixth transistor that receives the third scan signal and supplies an initialization voltage to the pixel electrode.

In one embodiment, the display device further comprises: a second light-blocking layer between the first light-blocking layer and the active layer; and a first capacitor connected to the gate electrode of the first transistor and a source electrode of the first transistor, the first capacitor including a first capacitor electrode in the first light-blocking layer electrically connected to the gate electrode of the first transistor, and a second capacitor electrode in the second light-blocking layer electrically connected to the source electrode of the first transistor.

In one embodiment, the first capacitor further includes: a third capacitor electrode electrically connected to the first capacitor electrode, the third capacitor electrode in the gate layer and including the gate electrode of the first transistor; and a fourth capacitor electrode electrically connected to the second capacitor electrode, the fourth capacitor electrode in the gate layer and facing the third capacitor electrode.

In one embodiment, the display device further comprises: a second capacitor connected to the source electrode of the first transistor and a driving voltage line that supplies a driving voltage, the second capacitor including a first capacitor electrode in the first light-blocking layer electrically connected to the driving voltage line, and a second capacitor electrode in the second light-blocking layer electrically connected to the source electrode of the first transistor.

In one embodiment, a display device comprises: a substrate; a first electrode of a first capacitor and a first scan line in a same layer on the substrate, the first electrode and the first scan line spaced apart from each other; a first buffer layer covering the first electrode and the first scan line; an active layer on the first buffer layer, the active layer including a first semiconductor area of a driving transistor and a second semiconductor area of an emission transistor; a second electrode of the first capacitor between the active layer and the first electrode of the first capacitor, the first buffer layer between the first electrode and the second electrode of the first capacitor; a gate layer on the active layer, the gate layer including a gate electrode of the driving transistor and a gate electrode of the emission transistor that is spaced apart from the gate electrode of the driving transistor, a first planarization layer over the gate layer; a source metal layer on the first planarization layer and including a connection electrode and an anode connection electrode that is spaced apart from the connection electrode, the connection electrode connected to the gate electrode of the driving transistor and the first electrode of the first capacitor and the anode connection electrode directly connected to the active layer; a pixel electrode on the source metal layer, the pixel electrode directly connected to the anode connection electrode; a light-emitting layer on the pixel electrode; and a common electrode on the light-emitting layer.

In one embodiment, at least a portion of the first scan line is non-overlapping with the first electrode and the second electrode of the first capacitor.

In one embodiment, the active layer further comprises: a drain electrode of the driving transistor at a first side of the first semiconductor area; a source electrode of the driving transistor at a second side of the first semiconductor area; a drain electrode of the emission transistor at a first side of the second semiconductor area; and a source electrode of the emission transistor at a second side of the second semiconductor area, wherein the source electrode of the driving transistor and the drain electrode of the emission transistor are integral with each other.

In one embodiment, the anode connection electrode is directly connected to the source electrode of the emission transistor.

In one embodiment, the display device further comprises: a data transistor having a gate electrode that is connected to the first scan line, the data transistor supplying a data voltage to the gate electrode of the driving transistor; and a data line that is in the source metal layer, the data line supplying the data voltage to the data transistor.

In one embodiment, the first electrode of the first capacitor is connected to the gate electrode of the driving transistor and the second electrode of the first capacitor is connected to the source electrode of the driving transistor and the drain electrode of the emission transistor.

In the display device according to the embodiments of the present specification, by including one source metal layer between transistors of the pixel circuit and the pixel electrode of the light-emitting element, it is possible to reduce the number of masks of the manufacturing process and reduce the manufacturing cost.

In the display device according to the embodiments of the present specification, it is possible to optimize the process by reducing the number of conductive layers.

However, effects obtainable from the present specification are not limited to the above-described effects, and other effects that are not mentioned will be able to be clearly understood by those skilled in the art to which the present specification pertains based on the following description.

Although one embodiment has been described above with reference to the accompanying drawings, those skilled in the art to which the specification pertains will be able to understand that the above-described technical configuration of the present invention can be carried out in other specific forms without changing the technical spirit or essential features thereof. Accordingly, it should be understood that the above-described embodiments are illustrative and not restrictive in all respects. In addition, the scope of the specification is described by the claims to be described below rather than the detailed description. In addition, the meaning and scope of the claims and all changed or modified forms derived from the equivalent concept should be construed as being included in the scope of the specification.

DESCRIPTION OF REFERENCE NUMERALS

| | |
|---|---|
| 10: display device | 100: display panel |
| 200: controller | 300: gate driving unit |
| 400: data driving unit | 500: power supply unit |
| LS1: first light-blocking layer | |
| LS2: second light-blocking layer | |
| ACTL: active layer | GTL: gate layer |
| SDL: source metal layer | ED: light-emitting element |

What is claimed is:

1. A display device comprising:
a substrate;
a first light-blocking layer on the substrate, the first light-blocking layer including a first scan line extending in a first direction;
an active layer including a semiconductor area of a first transistor, the active layer on the first light-blocking layer;
a gate layer including a gate electrode of the first transistor, the gate layer on the active layer;
a second transistor that receives a first scan signal from the first scan line and supplies a data voltage to the gate electrode of the first transistor,
a source metal layer on the gate layer, the source metal layer including an anode connection electrode that is directly connected to the active layer and receives a driving current flowing in the first transistor;
a pixel electrode on the source metal layer, the pixel electrode directly connected to the anode connection electrode;
a light-emitting layer on the pixel electrode; and
a common electrode on the light-emitting layer.

2. The display device of claim 1, further comprising:
a data line that supplies the data voltage, the data line on the source metal layer and extending in a second direction that intersects the first direction.

3. The display device of claim 1, further comprising:
a second scan line in the first light-blocking layer, the second scan line extending in the first direction; and
a third transistor that receives a second scan signal from the second scan line and supplies a reference voltage to the gate electrode of the first transistor.

4. The display device of claim 3, further comprising:
a first reference voltage line that supplies the reference voltage to the third transistor, the first reference voltage line in the source metal layer and extends in a second direction that intersects the first direction; and
a second reference voltage line that is electrically connected to the first reference voltage line, the second reference voltage line in the first light-blocking layer and extends in the second direction.

5. The display device of claim 3, further comprising:
a first light-emitting control line in the gate layer, the first light-emitting control line extending in the first direction; and
a fourth transistor that receives a first light-emitting signal from the first light-emitting control line and supplies a driving voltage to a drain electrode of the first transistor.

6. The display device of claim 5, further comprising:
a first driving voltage line that supplies the driving voltage, the first driving voltage line in the source metal layer and extends in a second direction that intersects the first direction; and
a second driving voltage line electrically connected to the first driving voltage line, the second driving voltage line in the first light-blocking layer and extending in the second direction.

7. The display device of claim 5, further comprising:
a second light-emitting control line in the gate layer, the second light-emitting control line extending in the first direction; and
a fifth transistor that receives a second light-emitting signal from the second light-emitting control line, the fifth transistor electrically connecting a source electrode of the first transistor to the pixel electrode.

8. The display device of claim 7, further comprising:
a third scan line in the gate layer, the third scan line extending in the first direction; and
a sixth transistor that receives a third scan signal from the third scan line and supplies an initialization voltage to the pixel electrode.

9. The display device of claim 8, further comprising:
a first initialization voltage line that supplies the initialization voltage to the sixth transistor, the first initialization voltage line in the source metal layer and extends in a second direction that intersects the first direction, and; and
a second initialization voltage line that is electrically connected to the first initialization voltage line, the second initialization voltage line in the first light-blocking layer and extends in the second direction.

10. The display device of claim 1, further comprising:
a second light-blocking layer between the first light-blocking layer and the active layer; and
a first capacitor connected to the gate electrode of the first transistor and a source electrode of the first transistor, the first capacitor including:
a first capacitor electrode of the first capacitor that is electrically connected to the gate electrode of the first transistor and is in the first light-blocking layer; and
a second capacitor electrode of the first capacitor that is electrically connected to the source electrode of the first transistor and is in the second light-blocking layer.

11. The display device of claim 10, wherein the first capacitor electrode and the second capacitor electrode of the first capacitor overlap the semiconductor area of the first transistor.

12. The display device of claim 10, wherein the first capacitor further includes:
a third capacitor electrode electrically connected to the first capacitor electrode, the third capacitor electrode in the gate layer and includes the gate electrode of the first transistor; and
a fourth capacitor electrode electrically connected to the second capacitor electrode, the fourth capacitor electrode in the gate layer and facing the third capacitor electrode.

13. The display device of claim 10, further comprising:
a second capacitor connected to a driving voltage line that supplies a driving voltage and the source electrode of the first transistor, the second capacitor including:
a first capacitor electrode of the second capacitor is in the first light-blocking layer and is electrically connected to the driving voltage line; and
a second capacitor electrode of the second capacitor is in the second light-blocking layer and electrically connected to the source electrode of the first transistor.

14. The display device of claim 13, wherein the second capacitor electrode of the first capacitor and the second capacitor electrode of the second capacitor are integral with each other.

15. A display device comprising:
a substrate;
a first light-blocking layer on the substrate;
a first scan line that supplies a first scan signal, the first scan line in the first light-blocking layer and extends in a first direction;
a second scan line that supplies a second scan signal, the second scan line in the first light-blocking layer and extends in the first direction;
an active layer including a semiconductor area of a first transistor, the active layer on the first light-blocking layer;
a gate layer including a gate electrode of the first transistor, the gate layer on the active layer;
a first light-emitting control line that supplies a first light-emitting signal, the first light-emitting control line in the gate layer and extends in the first direction;
a second transistor that receives the first scan signal and supplies a data voltage to the gate electrode of the first transistor;
a third transistor that receives the second scan signal and supplies a reference voltage to the gate electrode of the first transistor; and
a fourth transistor that receives the first light-emitting signal and supplies a driving voltage to a drain electrode of the first transistor.

16. The display device of claim 15, further comprising:
a second light-emitting control line that supplies a second light-emitting signal, the second light-emitting control line in the gate layer and extends in the first direction;
a fifth transistor that receives the second light-emitting signal, the fifth transistor connected to a source electrode of the first transistor;
a source metal layer on the gate layer, the source metal layer including an anode connection electrode that is directly connected to a source electrode of the fifth transistor; and
a pixel electrode on the source metal layer, the pixel electrode directly connected to the anode connection electrode.

17. The display device of claim 16, further comprising:
a third scan line that supplies a third scan signal, the third scan line in the gate layer and extends in the first direction; and
a sixth transistor that receives the third scan signal and supplies an initialization voltage to the pixel electrode.

18. The display device of claim 15, further comprising:
a second light-blocking layer between the first light-blocking layer and the active layer; and
a first capacitor connected to the gate electrode of the first transistor and a source electrode of the first transistor, the first capacitor including:
a first capacitor electrode of the first capacitor in the first light-blocking layer and electrode electrically connected to the gate electrode of the first transistor; and
a second capacitor electrode of the first capacitor in the second light-blocking layer and electrically connected to the source electrode of the first transistor.

19. The display device of claim 18, wherein the first capacitor further includes:
a third capacitor electrode electrically connected to the first capacitor electrode, the third capacitor electrode in the gate layer and includes the gate electrode of the first transistor; and
a fourth capacitor electrode electrically connected to the second capacitor electrode, the fourth capacitor electrode in the gate layer and facing the third capacitor electrode.

20. The display device of claim 18, further comprising:
a second capacitor connected to the source electrode of the first transistor and a driving voltage line that supplies a driving voltage, the second capacitor including:
a first capacitor electrode of the second capacitor in the first light-blocking layer and electrically connected to the driving voltage line; and
a second capacitor electrode of the second capacitor in the second light-blocking layer and electrically connected to the source electrode of the first transistor.

21. A display device comprising:
a substrate;
a first electrode of a first capacitor and a first scan line in a same layer on the substrate, the first electrode and the first scan line spaced apart from each other;
a first buffer layer covering the first electrode and the first scan line;
an active layer on the first buffer layer, the active layer including a first semiconductor area of a driving transistor and a second semiconductor area of an emission transistor;
a second electrode of the first capacitor between the active layer and the first electrode of the first capacitor, the first buffer layer between the first electrode and the second electrode of the first capacitor;
a gate layer on the active layer, the gate layer including a gate electrode of the driving transistor and a gate electrode of the emission transistor that is spaced apart from the gate electrode of the driving transistor;
a first planarization layer over the gate layer;
a source metal layer on the first planarization layer and including a connection electrode and an anode connection electrode that is spaced apart from the connection electrode, the connection electrode connected to the gate electrode of the driving transistor and the first electrode of the first capacitor and the anode connection electrode directly connected to the active layer;
a pixel electrode on the source metal layer, the pixel electrode directly connected to the anode connection electrode;
a light-emitting layer on the pixel electrode; and
a common electrode on the light-emitting layer.

22. The display device of claim 21, wherein at least a portion of the first scan line is non-overlapping with the first electrode and the second electrode of the first capacitor.

23. The display device of claim 21, wherein the active layer further comprises:
a drain electrode of the driving transistor at a first side of the first semiconductor area;
a source electrode of the driving transistor at a second side of the first semiconductor area;
a drain electrode of the emission transistor at a first side of the second semiconductor area;
a source electrode of the emission transistor at a second side of the second semiconductor area,
wherein the source electrode of the driving transistor and the drain electrode of the emission transistor are integral with each other.

24. The display device of claim 23, wherein the anode connection electrode is directly connected to the source electrode of the emission transistor.

25. The display device of claim 21, further comprising:
a data transistor having a gate electrode that is connected to the first scan line, the data transistor supplying a data voltage to the gate electrode of the driving transistor, and
a data line that is in the source metal layer, the data line supplying the data voltage to the data transistor.

26. The display device of claim 23, wherein the first electrode of the first capacitor is connected to the gate electrode of the driving transistor and the second electrode of the first capacitor is connected to the source electrode of the driving transistor and the drain electrode of the emission transistor.
